(19) United States
(12) Patent Application Publication
(10) Pub. No.: US 2026/0268436 A1
(43) Pub. Date: Sep. 10, 2026

(54) Image Processing Apparatus, Image Processing System, and Image Processing Program

(71) Applicant: Konica Minolta, Inc., Tokyo (JP)

(72) Inventors: Masanori YAMASHITA, Toyonaka-shi, Osaka (JP); Noriaki ASAMOTO, Kusatsu-shi, Shiga (JP)

(21) Appl. No.: 19/162,185

(22) PCT Filed: Feb. 28, 2024
(86) PCT No.: PCT/JP2024/007276

§ 371 Date: Sep. 4, 2025

(30) Foreign Application Priority Data
Mar. 10, 2023 (JP) 2023-037363

(51) Int. Cl. G06T 3/047; G06V 20/52; G06V 40/10; G06V 40/20

(52) U.S. Cl. CPC G06T 3/047; G06V 20/52; G06V 40/10; G06V 40/20

(57) ABSTRACT

A technique for readily selecting a part of a fish-eye image as a range of planar image formation is provided. An image processing apparatus is provided which has a function of selecting a part of a captured fish-eye image and a function of converting a range selected on the fish-eye image into a planar image. The image processing apparatus includes: an image input section that receives an input of a fish-eye image; a conversion coordinate designation section that designates a part on the fish-eye image as a range of planar image formation based on an input of a user; and an image conversion section that converts the designated range on the fish-eye image into a planar image.

### TECHNOLOGICAL FIELD

The present disclosure relates to an image processing technique, more specifically, a technique for designating a part of a fish-eye image and converting it into a planar image.

### BACKGROUND

A movable body such as a forklift is used for work in a factory, The movable body may be moved through a narrow passage in the factory or may be used in a place where there are many objects and/or people. Under such circumstances, the movable body may collide with an object or a person to result in occurrence of an accident. Therefore, an operator of the movable body is required to stop the work and confirm safety therearound. However, such safety confirmation leads to complication of the work of the operator, thus resulting in decreased productivity of the work.

To address such a problem, a technique for confirming safety around the operator using a fish-eye lens camera or the like has been known. However, it is difficult to intuitively understand a fish-eye image obtained by the fish-eye lens camera, and the fish-eye image is not suitable for image recognition processing. Therefore, a technique for converting the fish-eye image into a format that is intuitively understandable and suitable for the image recognition processing has been required.

Regarding the technique using the fish-eye lens camera, for example, Japanese Laid-Open Patent Publication No. 2019-003676 (PTL 1) discloses an image processing system. The image processing system is configured as follows: “An image processing apparatus includes: reception means for receiving an input value defining an output range; generation means for generating a three-dimensional model in which a target image is attached on a three-dimensional shape; determination means for determining a position of a viewpoint and a viewing angle based on an input value; and projection means for projecting the three-dimensional model from the viewpoint. When the input value falls within a first range, the determination means preferentially changes the viewing angle so as to change a range falling within the field of view of the target image, whereas when the input value falls within a second range that is located on the wide-field-of-view side with respect to the first range, the determination means preferentially changes the position of the viewpoint so as to change the range falling within the field of view.” (see [Abstract]).

### CITATION LIST

### Patent Literature

PTL 1: Japanese Laid-Open Patent Publication No. 2019-003676

### SUMMARY

### Technical Problem

According to the technique disclosed in PTL 1, a part of the fish-eye image cannot be readily selected as a range of planar image formation. For example, it is assumed that the operator who operates the movable body has found an attention-attracting part in a part of the fish-eye image. The operator needs to perform both an operation on the movable body and an operation of designating the part of the fish-eye image. Therefore, it is desirable that the operation of designating the part of the fish-eye image is simple. Therefore, a technique for readily selecting a part of a fish-eye image as a range of planar image formation has been required.

The present disclosure has been made in consideration of the above-described background, and an object in a certain aspect is to provide a technique for readily selecting a part of a fish-eye image as a range of planar image formation.

### Solution to Problem

According to a certain embodiment, an image processing apparatus is provided. The image processing apparatus includes: an image input section that receives an input of a fish-eye image; a conversion coordinate designation section that designates a part on the fish-eye image as a range of planar image formation based on an input of a user; and an image conversion section that converts the designated range on the fish-eye image into a planar image.

In a certain aspect, a camera that captures the fish-eye image is provided at a movable body. The fish-eye image captures an operator of the movable body. The conversion coordinate designation section analyzes a gesture of the operator captured in the fish-eye image, and the conversion coordinate designation section designates, as the range of the planar image formation, a range indicated by the gesture.

In a certain aspect, the conversion coordinate designation section receives an input of one or more points on the fish-eye image, and the conversion coordinate designation section designates, as the range of the planar image formation, a range centered on each of the one or more points.

In a certain aspect, the conversion coordinate designation section receives an input of surrounding a part on the fish-eye image by a line, and the conversion coordinate designation section designates, as the range of the planar image formation, each of one or more ranges surrounded by the line.

In a certain aspect, the conversion coordinate designation section consecutively receives an input of one or more ranges on the fish-eye image, and the conversion coordinate designation section sequentially designates each of the one or more ranges as the range of the planar image formation.

In a certain aspect, the image processing apparatus further includes an image recognition section that performs image recognition processing onto the planar image.

In a certain aspect, the image processing apparatus further includes an output section that outputs the fish-eye image and the planar image. The output section outputs an image recognition result and/or an alert that is based on the image recognition result.

According to another embodiment, an image processing system is provided. The image processing system includes: a camera having a fish-eye lens; an image input section that receives a fish-eye image from the camera; a conversion coordinate designation section that designates a part on the fish-eye image as a range of planar image formation based on an input of a user; and an image conversion section that converts the designated range on the fish-eye image into a planar image.

According to still another embodiment, an image processing system is provided. The image processing program causes a computer to perform: receiving an input of a fish-eye image from a camera; designating a part on the fish-eye image as a range of planar image formation based on an input of a user; and converting the designated range on the fish-eye image into a planar image.

### Advantageous Effects of Invention

According to a certain embodiment, it is possible to readily select a part of a fish-eye image as a range of planar image formation.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating an example of a system 10 according to the present embodiment.

FIG. 2 is a diagram illustrating an example of a system 20 according to the present embodiment.

FIG. 3 is a diagram illustrating an example of a functional configuration of each of the systems 10, 20.

FIG. 4 is a diagram illustrating an example of a hardware configuration of each of apparatuses 100, 200.

FIG. 5 is a diagram illustrating an example of a screen 500 output by each of the systems 10, 20.

FIG. 6 is a diagram illustrating an example of a procedure for converting a part of a fish-eye image into a planar image.

FIG. 7 is a diagram illustrating a first example of a method of designating a range of planar image formation from the fish-eye image.

FIG. 8 is a diagram illustrating a second example of a method of designating a range of planar image formation from the fish-eye image.

FIG. 9 is a diagram illustrating an example of a relation between the designated range and a planar image to be generated.

FIG. 10 is a diagram illustrating a third example of a method of designating a range of planar image formation from the fish-eye image.

FIG. 11 is a diagram illustrating a fourth example of a method of designating a range of planar image formation from the fish-eye image.

FIG. 12 is a diagram illustrating a fifth example of a method of designating a range of planar image formation from the fish-eye image.

FIG. 13 is a diagram illustrating a sixth example of a method of designating a range of planar image formation from the fish-eye image.

FIG. 14 is a diagram illustrating a seventh example of a method of designating a range of planar image formation from the fish-eye image.

FIG. 15 is a diagram illustrating an example of a procedure for calculating a horizontal rotation angle and a vertical rotation angle at the center of the designated range.

FIG. 16 is a diagram illustrating an example of a procedure for calculating an FOV at the center of the designated range.

FIG. 17 is a diagram illustrating an example of a procedure of internal processing of each of the systems 10, 20.

### DETAILED DESCRIPTION OF EMBODIMENTS

Hereinafter, embodiments of the technical concept according to the present disclosure will be described with reference to figures. In the following description, the same components are denoted by the same reference numerals. Their names and functions are the same. Therefore, detailed description thereof will not be repeated.

### A. Example of System to Which Technique of the Present Disclosure is Applicable

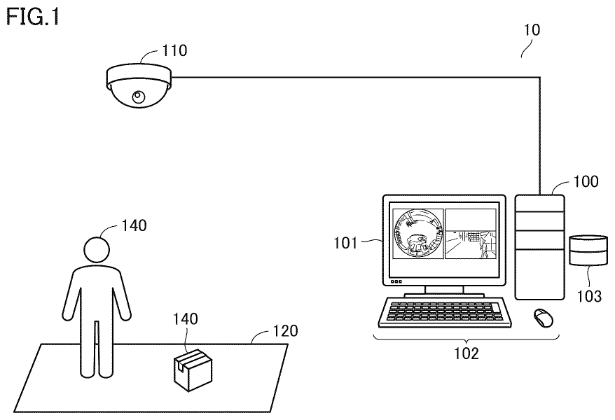

FIG. 1 is a diagram illustrating an example of a system 10 according to the present embodiment. With reference to FIG. 1, the following describes a configuration of a system to which the technique of the present disclosure can be applied, a problem when a fish-eye image is used for safety confirmation, and terms used in the present specification.

(a. System Configuration)

The system 10 according to the present embodiment is used for safety confirmation around a movable body. The movable body is any self-propelled machine, such as a forklift, a heavy machine, an AGV (Automatic Guided Vehicle). The system 10 can be used at any place where the movable body is used, such as a factory, a harbor, a construction site, a laboratory, and a warehouse. The system 10 uses a camera 110 to capture a fish-eye image of the movable body and its surroundings. The system 10 can present the fish-eye image to a user. The user may be an operator who operates the movable body or may be a monitoring person different from the operator. Furthermore, the system 10 can perform editing processing and image recognition processing onto the fish-eye image so as to detect such a risk that the movable body may collide with a person or object therearound. The system 10 according to the present embodiment includes an apparatus 100 and the camera 110. The apparatus 100 at least includes an output device 101, an input device 102, and a storage 103.

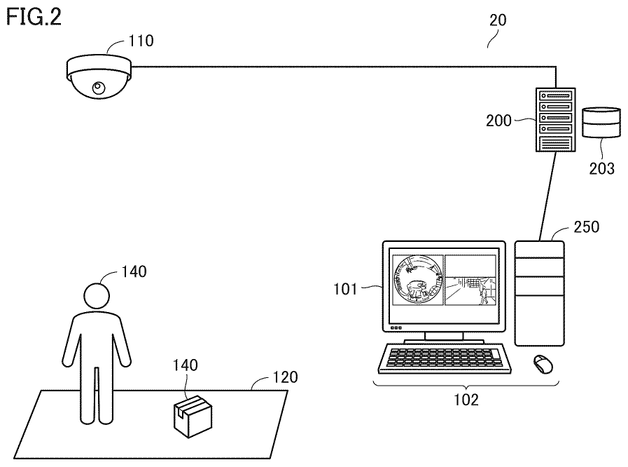

The camera 110 captures the image of the movable body and the surroundings of the movable body in a monitoring area 120. The image may capture a target 140 around the movable body. The target 140 is any object that may come into contact with the movable body. The target 140 includes a person, a movable body, a shelf, a wall, and any other object. The image captured by the camera 110 is a fish-eye image. In the present specification, the image includes a video. It can be said that the video is a series of images. The camera 110 can capture not only the image but also the video. The technique described in the present specification is applicable to not only the image but also the video. In practice, each of the system 10 and a system 20 (see FIG. 2) can perform planar image formation processing and image recognition processing onto images per frame (image) of the video. Therefore, the image in the present specification may be read as the video.

Furthermore, the camera 110 transmits the image to the apparatus 100. The camera 110 is connected to the apparatus 100 via a network. The network may include a wireless network, a wired network, a LAN (Local Area Network), a public network, and any other network. According to a certain embodiment, the camera 110 may be an omnidirectional camera in which a plurality of cameras are combined.

According to a certain embodiment, the camera 110 may be provided on a ceiling of the monitoring area. According to another embodiment, the camera 110 may be provided at the movable body. In this case, the camera 110 can be provided at the movable body via a stabilizer, a pole, and the like.

The apparatus 100 performs the image editing processing and the image recognition processing. The image editing processing includes processing of converting a part of the fish-eye image into a planar image. The part of the fish-eye image having been converted into the planar image is output as a planar image. More specifically, the apparatus 100 receives, from the user, an input of designating a part of the fish-eye image. The apparatus 100 converts the designated part of the fish-eye image into the planar image. Furthermore, the apparatus 100 may perform various types of image recognition processing onto the planar image. As an example, the apparatus 100 can perform processing of recognizing a person, processing of recognizing a movable body, or any other image recognition processing onto the planar image. The apparatus 100 can output an alert or the like based on an execution result of the image recognition processing.

According to a certain embodiment, the apparatus 100 may be provided at the movable body. In this case, the operator (user) of the movable body can monitor a display of the output device 101 while operating the movable body. According to another embodiment, the apparatus 100 may be provided at a position away from the movable body. In this case, a monitoring person (user) at a position different from that of the operator of the movable body can monitor the display of the output device 101.

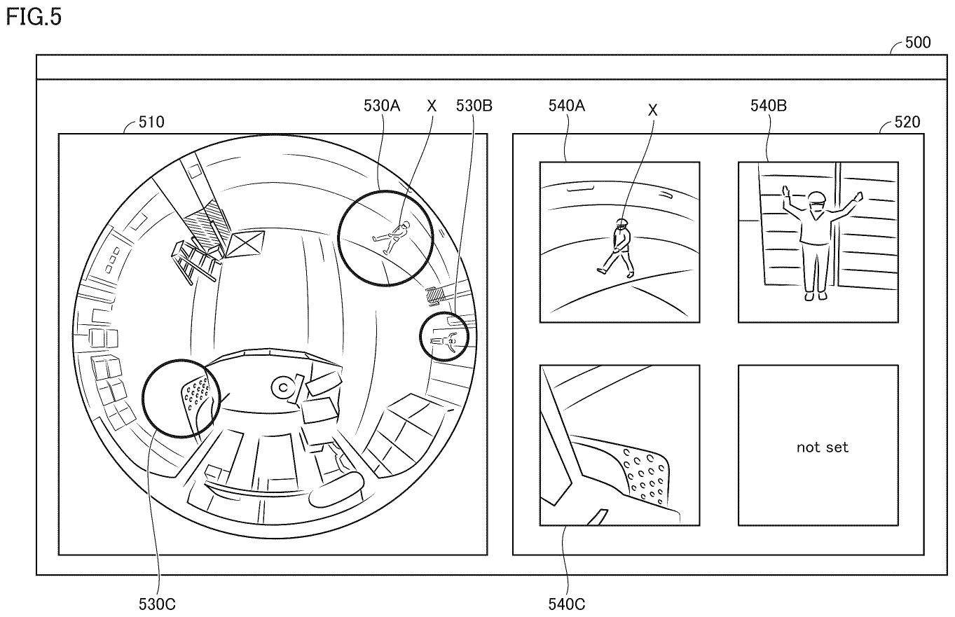

The output device 101 is a display, a speaker, or any other device for outputting information, each of which is connected to the apparatus 100. The output device 101 is connected to the apparatus 100 via an output interface 6. According to a certain embodiment, the output device 101 may be incorporated in the apparatus 100. The output device 101 outputs the fish-eye image, one or more planar images indicating a part of the fish-eye image, and an alert. As an example, the output device 101 outputs a screen 500 (see FIG. 5). By referring to the information output by the output device 101, the user can know that there is such a risk that the movable body may come into contact with a target therearound. Furthermore, by referring to the information output by the output device 101, the user can know a target to which attention should be paid around the movable body.

The input device 102 is a mouse, a keyboard, a microphone, a touch screen, or any other device for inputting information, each of which is connected to the apparatus 100. The input device 102 is connected to the apparatus 100 via an input interface 5. According to a certain embodiment, the input device 102 may be incorporated in the apparatus 100. The input device 102 receives an input of designating a part of the fish-eye image from the user. The apparatus 100 converts the designated part of the fish-eye image into a planar image.

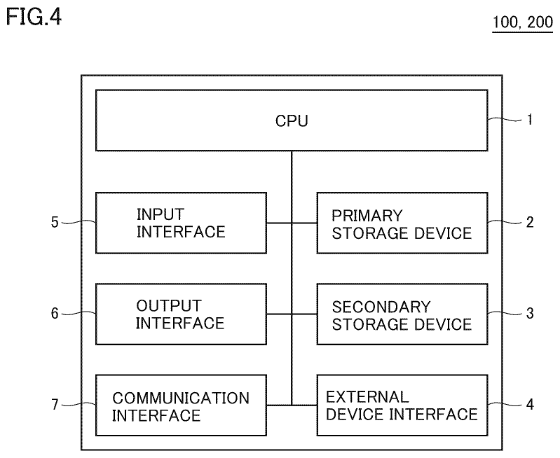

The storage 103 stores the captured image. Further, the storage 103 stores various settings of the system 10. The settings of the system 10 includes a setting of the method of designating the part of the fish-eye image, a setting when forming the fish-eye image into the planar image, and the like. Moreover, the storage 103 stores a program for realizing the technique of the present disclosure. According to a certain embodiment, the storage 103 may be a secondary storage device 3 (see FIG. 4). According to another embodiment, the storage 103 may be connected to the apparatus 100 via an external device interface 4 (see FIG. 4).

(b. Problem When Fish-Eye Image is Used for Safety Confirmation)

Next, the problem when the fish-eye image is used for safety confirmation will be described. The fish-eye image is an image that covers a range of 180 degrees, which is not covered by the field of view of a human. In the fish-eye image, a subject is distorted to have a hemispherical shape. Therefore, even when the user sees the fish-eye image, the user may be unable to intuitively understand a situation around the movable body. Moreover, existing image recognition libraries, AI models, and the like are often based on such an assumption that planar images are processed. Therefore, many of the existing image recognition libraries and AI models cannot be used for the fish-eye image.

Therefore, in order to solve the above-described problem, each of the systems 10, 20 provides the user with a function for readily selecting a part of the fish-eye image. Each of the systems 10, 20 provides a function of forming the selected part of the fish-eye image into a planar image. Furthermore, each of the systems 10, 20 provides a function of presenting, to the user, the planar image generated from the part of the fish-eye image. In this way, the user can readily select a particularly attention-attracting part in the fish-eye image and can obtain the planar image of the selected part. As a result, the user can intuitively understand what is captured in the particularly attention-attracting part in the fish-eye image. Also, each of the systems 10, 20 can use many of the existing image recognition libraries and AI models for the generated planar image.

(c. Terms)

In the present specification, the “system” includes a configuration constituted of one or a plurality of apparatuses, and a server. When the system is constituted of one apparatus, the system may be read as an apparatus. Moreover, the system also includes a virtual machine and a container built in a cloud environment, or a configuration constituted of at least a part of them. Furthermore, the apparatus may be any information processing apparatus such as a personal computer, a workstation, a server device, a tablet, or a smartphone. The apparatus may also be a combination of these.

According to a certain embodiment, the system may be connected to input/output devices such as a display and a keyboard, and may be used by the user. According to another embodiment, the system may provide various functions to the user as a service or a web application via the network. In this case, the user may use the functions of the system via a browser or client software installed in the user's terminal.

In the present specification, the “movable body” includes any object including any moving means such as wheels, caterpillar tracks, feet, magnetic force, or pneumatic pressure, Further, the movable body may be an unmanned machine or a manned machine. For example, the movable body includes a forklift, an AMR (Autonomous Mobile Robot), an AGV, an automobile, and a heavy machine. Moreover, the movable body can include a drone or the like that moves at a low altitude.

In the present specification, the “target” is a target to be monitored by each of the systems 10, 20. The target may include a movable object and/or a stationary object. Moreover, the object may include a living object and a non-living object. As an example, the target may include a person, an AMR, an AGV, or any movable body operated by a person. For example, each of the person, the AMR, and the AGV around the movable body can be the target. Moreover, another movable body around the movable body can also be the target. According to a certain embodiment, an object to serve as the target can be input in advance to each of the systems 10, 20.

In the present specification, the “image” includes a video and an image obtained by the camera 110. Each of the systems 10, 20 may use the camera 110 to obtain a captured image only at a certain moment. Moreover, each of the systems 10, 20 may use the camera 110 to acquire a video of a certain period. It can also be said that the video of the certain period is a set of consecutive images. Therefore, the image in the present specification may be read as the video.

In the present specification, the “fish-eye image” is an image captured by a fish-eye lens camera. The fish-eye image is an image that covers a range of 180 degrees, which is not covered by the field of view of a human.

In the present specification, the “user” is a person who uses each of the systems 10, 20. The user may be an operator of the movable body. In this case, each of the apparatuses 100, 250 (see FIG. 2) may be provided in the vicinity of the seat of the movable body. The user may be a monitoring person different from the operator of the movable body. In this case, each of the apparatuses 100, 250 may be provided at a position away from the movable body.

FIG. 2 is a diagram illustrating an example of the system 20 according to the present embodiment. Unlike the system 10, the system 20 includes: an apparatus 200 operated as a server; and an apparatus 250 operated as a terminal.

The camera 110 transmits the captured image to the apparatus 200. The camera 110 is connected to the apparatus 200 via a network. The network can include a wireless network, a wired network, a LAN, a public network, and any other network. According to a certain embodiment, the camera 110 may be provided on a ceiling of the monitoring area. According to another embodiment, the camera 110 may be provided at the movable body. In this case, the camera 110 can be provided at the movable body via a stabilizer, a pole, and the like.

The apparatus 200 has a function equivalent to that of the apparatus 100 of the system 10. The apparatus 200 performs the image editing processing and the image recognition processing. The image editing processing includes processing of forming a part of the fish-eye image into a planar image. The part of the fish-eye image having been formed into the planar image is output as the planar image. Furthermore, the apparatus 200 functions as a server. In response to a request from the apparatus 250, the apparatus 200 transmits, to the apparatus 250, the fish-eye image, the planar image indicating the part of the fish-eye image, and/or the execution result of the image recognition processing. According to a certain embodiment, the apparatus 200 may function as a web application. In this case, the apparatus 250 may communicate with the apparatus 200 via the browser. According to another embodiment, the apparatus 200 may be one or more apparatuses, or a server application, a virtual machine, an instance, a container, or the like on a cloud environment.

The apparatus 200 includes a storage 203. The storage 203 stores various types of setting of the system 20. The setting of the system 20 includes a setting of the method of designating the part of the fish-eye image, a setting when forming the fish-eye image into the planar image, and the like. The storage 203 stores a program for realizing the technique of the present disclosure. According to a certain embodiment, the storage 203 may be the secondary storage device 3. According to another embodiment, the storage 203 may be connected to the apparatus 200 via the external device interface 4.

The apparatus 250 is operated as a terminal that presents, to a user, information received from the apparatus 200. As an example, the apparatus 250 can display a screen 500 on the display of the apparatus 250. Furthermore, the apparatus 250 receives, from the user, an input of designating a part of the fish-eye image. As with the apparatus 100, the apparatus 250 includes an output device 101 and an input device 102. The apparatus 250 transmits information of the designation of the part of the fish-eye image to the apparatus 200. Based on the received information of the designation of the part of the fish-eye image, the apparatus 200 generates a planar image. The apparatus 200 transmits the generated planar image to the apparatus 250. The apparatus 250 displays the received planar image on the display of the apparatus 250. The apparatus 250 may display the received planar image on a part of the screen 500.

According to a certain embodiment, the apparatus 250 may be provided at the movable body. In this case, the operator (user) of the movable body can monitor the display of the output device 101 while operating the movable body. According to another embodiment, the apparatus 250 may be provided at a position away from the movable body. In this case, a monitoring person (user) located at a position different from the position of the operator of the movable body can monitor the display of the output device 101.

As described above, the system 20 includes the server (apparatus 200) that provides image processing and image recognition functions, and the terminal (apparatus 250). Thus, two or more users can use the functions of the apparatus 200 via the apparatus 250.

According to a certain embodiment, each of the apparatus 100 of the system 10 and the apparatuses 200, 250 of the system 20 may be a personal computer, a server device, a workstation, a tablet, a smartphone, or any other information processing apparatus.

### B. Functions and Hardware Configuration of System

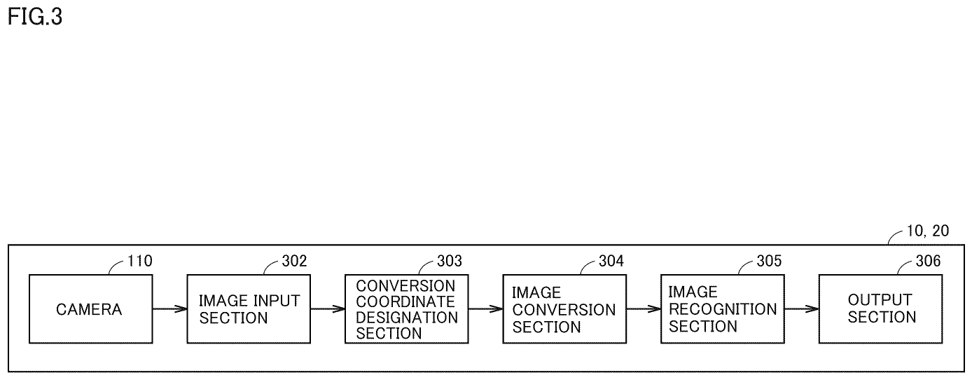

FIG. 3 is a diagram illustrating an example of a functional configuration of each of the systems 10, 20. According to a certain embodiment, part or whole of functions illustrated in FIG. 3 can be implemented as a program. In this case, each function is implemented by executing the program on hardware illustrated in FIG. 4. According to another embodiment, part of the functions illustrated in FIG. 3 may be implemented as hardware. In the case of the system 10, the apparatus 100 can have the functions illustrated in FIG. 3. In the case of the system 20, the apparatus 200 can have the functions illustrated in FIG. 3.

Each of the systems 10, 20 includes, as main functions, an image input section 302, a conversion coordinate designation section 303, an image conversion section 304, an image recognition section 305, and an output section 306.

The image input section 302 acquires an image from the camera 110. The image sent from the camera 110 is a fish-eye image. The image input section 302 outputs the acquired image to the conversion coordinate designation section 303.

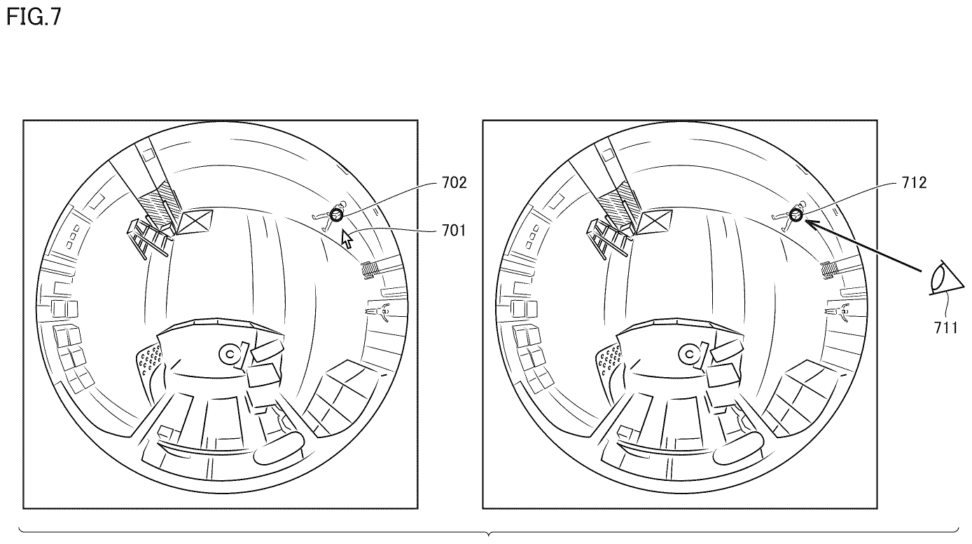

The conversion coordinate designation section 303 receives an input of designating a part of the fish-eye image from the user. The conversion coordinate designation section 303 designates or determines the center coordinates of a planar image based on the input. As an example, when a point is input, the conversion coordinate designation section 303 designates or determines the coordinates of the point as the center coordinates of the planar image. As another example, when a range is input, the conversion coordinate designation section 303 designates or determines the coordinates of the center of the range as the center coordinates of the planar image. The conversion coordinate designation section 303 outputs information of the center coordinates of the planar image to the image conversion section 304. When the input of designating the part of the fish-eye image is the range, the conversion coordinate designation section 303 outputs range information to the image conversion section 304 in addition to the center coordinates of the planar image. The conversion coordinate designation section 303 can receive the input of designating the part (point or range) of the fish-eye image, for example, by each of various designation methods illustrated in FIGS. 7 to 14.

According to a certain embodiment, the input from the user may be an input of designating one or more points on the fish-eye image. According to another embodiment, the input from the user may be an input of designating one or more ranges on the fish-eye image. Each of the systems 10, 20 includes a user interface (UI) for receiving the input of designating the part of the fish-eye image. Each of the systems 10, 20 displays the UI on the display viewed by the user. As an example, the screen 500 may have a function of the UI for receiving the input of designating the part of the fish-eye image. The conversion coordinate designation section 303 may provide the user with the UI for receiving the input of designating the part of the fish-eye image.

The image conversion section 304 converts the part of the fish-eye image into a planar image based on the information of the center coordinates of the planar image. It can also be said that the image conversion section 304 generates a planar image including the selected part of the fish-eye image. Therefore, the planar image output from the image conversion section 304 is an image into which the part of the fish-eye image has been converted and is also an image generated from the part of the fish-eye image. As an example, it is assumed that the image conversion section 304 receives only the center coordinates of the planar image from the conversion coordinate designation section 303. In this case, the image conversion section 304 generates a planar image having a default size with the designated coordinates as its center. As another example, it is assumed that the image conversion section 304 receives the center coordinates and the range information of the planar image from the conversion coordinate designation section 303. In this case, the image conversion section 304 generates a planar image having a size including the range designated by the user with the designated coordinates as its center. The image conversion section 304 outputs the generated planar image to the image recognition section 305.

The image recognition section 305 can perform any image recognition processing onto the input planar image. As an example, the image recognition section 305 can perform human skeleton estimation processing, detection processing for an object that is moved, estimation processing for a distance from the movable body to the target, or the like, onto the planar image. The image recognition section 305 outputs a result of the image recognition processing to the output section 306.

The output section 306 outputs the fish-eye image, the planar image, and the result of the image recognition processing. The planar image is a planar image generated from the fish-eye image. The result of the image recognition processing is a result of the image recognition processing performed onto the planar image. The output includes: displaying on the display; and transmission of information to another apparatus. In the case of the system 10, the output section 306 of the apparatus 100 can display the fish-eye image, the planar image, and the result of the image recognition processing on the output device 101 of the apparatus 100. In the case of the system 20, the output section 306 of the apparatus 200 can transmit the fish-eye image, the planar image, and the result of the image recognition processing to the apparatus 250.

As described above, each of the systems 10, 20 (the apparatuses 100, 200) at least includes: the image input section 302 that receives an input of a fish-eye image; the conversion coordinate designation section 303 that designates a part on the fish-eye image as a range of planar image formation based on an input of a user; and the image conversion section 304 that converts the designated range on the fish-eye image into a planar image.

Moreover, each of the systems 10, 20 (the apparatuses 100, 200) further includes the image recognition section 305 that performs image recognition processing onto the planar image. Each of the systems 10, 20 further includes the output section 306 that outputs the fish-eye image and the planar image. The output section 306 can output an image recognition result and/or an alert that is based on the image recognition result.

FIG. 4 is a diagram illustrating an example of a hardware configuration of each of the apparatuses 100, 200. According to a certain embodiment, the apparatus 250 may also include the hardware configuration illustrated in FIG. 4. Each of the apparatuses 100, 200 includes the CPU (Central Processing Unit) 1, the primary storage device 2, the secondary storage device 3, the external device interface 4, the input interface 5, the output interface 6, and the communication interface 7.

The CPU 1 may execute a program for implementing various functions of each of the apparatuses 100, 200. The CPU 1 is constituted of, for example, at least one integrated circuit. According to a certain embodiment, each of the apparatuses 100, 200 may include, for example, at least one CPU, at least one GPU (Graphics Processing Unit), at least one FPGA (Field Programmable Gate Array), at least one ASIC (Application Specific Integrated Circuit), a combination thereof, or the like.

The primary storage device 2 stores a program to be executed by the CPU 1 and data to be referred to by the CPU 1. In a certain aspect, the primary storage device 2 can be implemented by a DRAM (Dynamic Random Access Memory), an SRAM (Static Random Access Memory), or the like.

The secondary storage device 3 is a nonvolatile memory, and stores a program to be executed by the CPU 1 and data to be referred to by the CPU 1. In that case, the CPU 1 executes the program read from the secondary storage device 3 to the primary storage device 2 and refers to the data read from the secondary storage device 3 to the primary storage device 2. In a certain aspect, the secondary storage device 3 may be implemented by a HDD (Hard Disk Drive), an SSD (Solid State Drive), an EPROM (Erasable Programmable Read Only Memory), an EEPROM (Electrically Erasable Programmable Read Only Memory), a flash memory, or the like.

The external device interface 4 can be connected to any external device such as a printer, a scanner, a camera, and an external HDD. In a certain aspect, the external device interface 4 can be implemented by a USB (Universal Serial Bus) terminal or the like.

The input interface 5 can be connected to any input device such as a keyboard, a mouse, a touch pad or a game pad. In a certain aspect, the input interface 5 can be implemented by a USB terminal, a PS/2 terminal, a Bluetooth (registered trademark) module, and the like.

The output interface 6 can be connected to any output device such as a cathode-ray tube display, a liquid crystal display, or an organic EL (Electro-Luminescence) display. In a certain aspect, the output interface 6 can be implemented by a USB terminal, a D-sub terminal, a DVI (Digital Visual Interface) terminal, an HDMI (registered trademark) (High-Definition Multimedia Interface) terminal, a display port terminal, and the like.

The communication interface 7 is connected to other devices via a wired network or a wireless network. In a certain aspect, the communication interface 7 can be implemented by a wired LAN (Local Area Network) port, a Wi-Fi (registered trademark) (Wireless Fidelity) module, and the like. In another aspect, communication interface 7 can transmit and receive data using a communication protocol such as TCP/IP (Transmission Control Protocol/Internet Protocol) or UDP (User Datagram Protocol).

### C. Example of Screen of System and Procedure of Planar Image Formation Processing

FIG. 5 is a diagram illustrating an example of the screen 500 output by each of the systems 10, 20. The screen 500 is displayed on the output device 101 of the apparatus 100 or the output device 101 of the apparatus 250. The screen 500 at least includes a first displaying region 510 and a second displaying region 520.

The first displaying region 510 displays a fish-eye image. The fish-eye image displayed in the first displaying region 510 is an image captured by the camera 110. Each of the systems 10, 20 can update the first displaying region 510 whenever a fish-eye image is acquired from the camera 110. Therefore, it can be said that the first displaying region 510 displays a fish-eye video.

The first displaying region 510 also has a function as a UI for receiving, from the user, an input of designating a part of the fish-eye image. As an example, the user can designate a part of the fish-eye image via any input device such as a mouse, a keyboard, a touch screen, an eye tracking device, or a camera. For example, it is assumed that the user uses a mouse cursor to click a certain position of the fish-eye image on the first displaying region 510. In this case, each of the systems 10, 20 can convert a certain range from the clicked position serving as the center into a planar image. As another example, it is assumed that the user touches the touch screen with a finger so as to surround a range of a part of the fish-eye image in the first displaying region 510. In this case, each of the systems 10, 20 can convert the surrounded range touched with the finger into a planar image.

The generated converted image is displayed in the second displaying region 520. In the example of FIG. 5, the user selects ranges 530A, 530B, 530C from the fish-eye image on the first displaying region 510.

The second displaying region 520 displays one or more planar images. In the example of FIG. 5, the second displaying region 520 displays three planar images 540A, 540B, 540C. The planar images 540A, 540B, 540C correspond to the ranges 530A, 530B, 530C, respectively. The exemplary displaying in FIG. 5 is merely an example, and the second displaying region 520 can display one or more planar images, i.e., any number of planar images. The plurality of planar images 540A, 540B, 540C displayed on the screen 500 may be collectively referred to as a planar image 540.

The user can select an attention-attracting part in the fish-eye image in the first displaying region 510. The second displaying region 520 displays a planar image including the selected part. Thus, the user can readily convert the attention-attracting part in the fish-eye image into a planar image, and can check it.

According to a certain embodiment, each of the systems 10, 20 can display a mark for each of the designated ranges (the ranges 530A, 530B, 530C) on the fish-eye image. Thus, the user can know what range on the fish-eye image is currently converted into the planar image.

According to another embodiment, for the range designated on the fish-eye image, the coordinates from the center of the fish-eye image may be fixed. For example, it is assumed that the center of the range 530A is coordinates (A, B) when viewed from the center of the fish-eye image. In this case, the center of the range 530A is fixed at a position of the coordinates (A, B) when viewed from the center of the fish-eye image. As a result, the corresponding planar image 540A is always a planar image at the position of the coordinates (A, B) when viewed from the center of the fish-eye image.

Further, according to another embodiment, the range designated on the fish-eye image may follow a target within the designated range. For example, a target X is present in the range 530A. In this case, when the target X is moved, the range 530A is also moved to follow the target X. As a result, the corresponding planar image 540A is always a planar image in which the target X is captured.

Further, according to another embodiment, the screen 500 may output an execution result of certain image recognition processing performed onto the planar image 540. For example, it is assumed that a distance from the target X captured in the planar image 540A to the movable body has become equal to or shorter than a certain distance. In this case, the screen 500 can output an alert indicating that the distance from the target X captured in the planar image 540A to the movable body has become equal to or shorter than the certain distance. The alert may be in any output format.

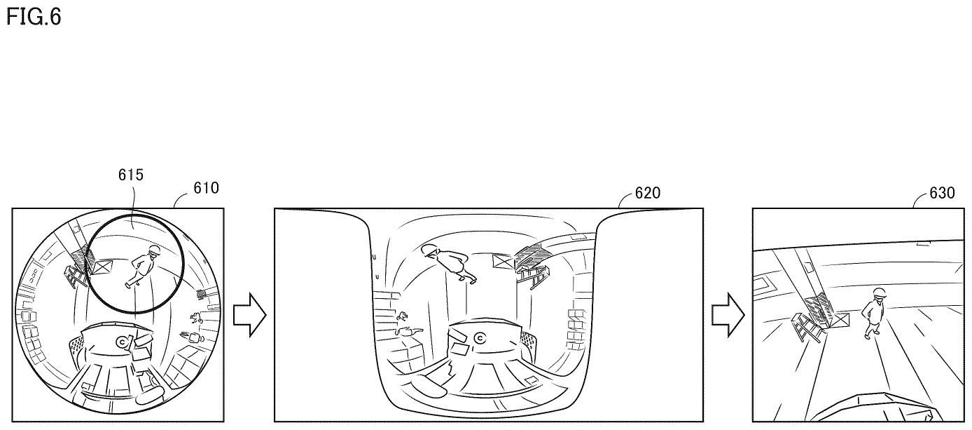

FIG. 6 is a diagram illustrating an example of the procedure for converting the part of the fish-eye image into the planar image. It is assumed that each of the systems 10, 20 has acquired a fish-eye image 610 from the camera 110. It is also assumed that each of the systems 10, 20 has received an input of designating a range 615 from the user via the screen 500 or the like. In this case, each of the systems 10, 20 converts the fish-eye image 610 into an equirectangular image 620. Next, each of the systems 10, 20 converts the equirectangular image 620 into a planar image 630. The planar image 630 finally obtained is a planar image including the range 615. That is, the planar image 630 is an image obtained by forming the range of the part of the fish-eye image 610 into the planar image. According to a certain embodiment, each of the systems 10, 20 may convert the fish-eye image 610 into the planar image 630 using any other algorithm.

### D. Method of Designating Range of Planar Image Formation

Next, with reference to FIGS. 7 to 14, some examples of variations of the method of designating the part of the fish-eye image will be described. Each of the methods illustrated in FIG. 7 to FIG. 14 is an example, and each of the systems 10, 20 may receive the input of designating the part of the fish-eye image by any method other than the methods illustrated in FIG. 7 to FIG. 14.

FIG. 7 is a diagram illustrating a first example of the method of designating the range of the planar image formation from the fish-eye image. The first example is a method of designating a point on the fish-eye image. The user can designate a point on the fish-eye image using any means. Each of the systems 10, 20 generates a planar image with the designated point as its center.

As an example, the user may use a cursor 701 to designate a point 702 on the fish-eye image in the first displaying region 510. The cursor 701 may be a mouse cursor or may indicate a touch position on the touch screen. As another example, the user may use a line of sight 711 to designate a point 712 on the fish-eye image in the first displaying region 510. In this case, each of the systems 10, 20 includes an eye tracking device (not illustrated) for tracking the line of sight 711 of the user.

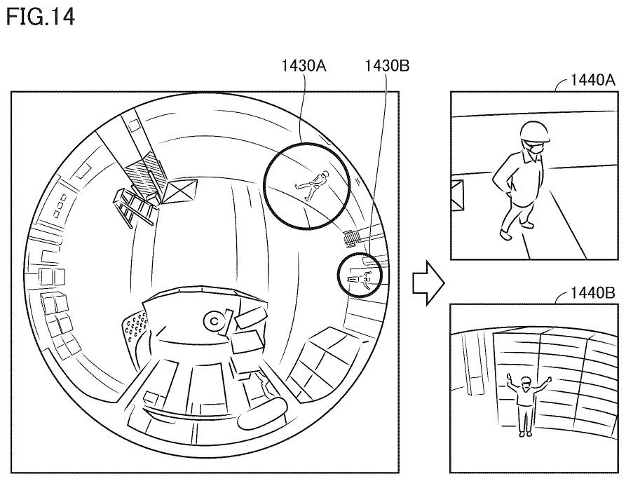

As in each of the examples illustrated in FIGS. 7 and 14, the conversion coordinate designation section 303 receives an input of one or more points on the fish-eye image. Moreover, the conversion coordinate designation section 303 designates, as the range of the planar image formation, a range centered on each of the one or more points.

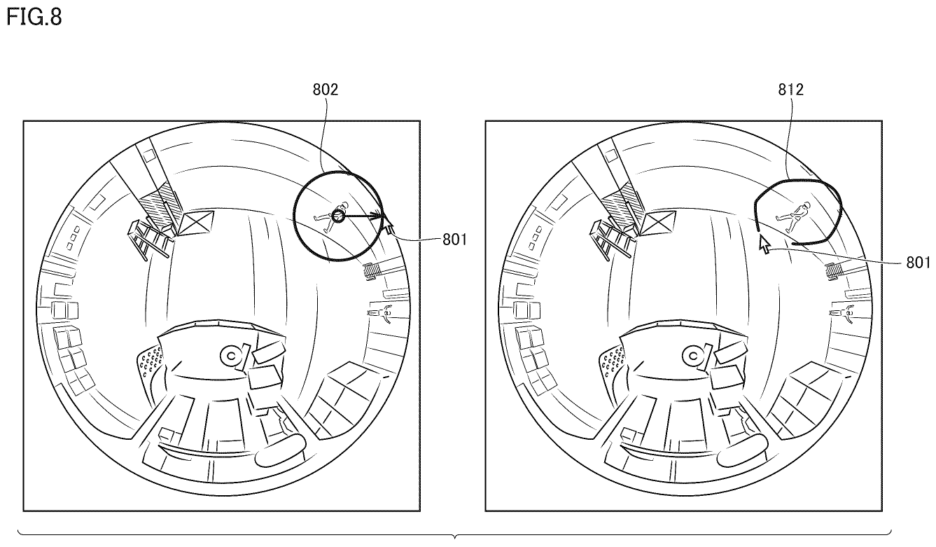

FIG. 8 is a diagram illustrating a second example of the method of designating the range of the planar image formation from the fish-eye image. The second example is a method of designating any range on the fish-eye image. The user can designate any range on the fish-eye image using any means. Each of the systems 10, 20 generates a planar image including the designated range.

As an example, the user may designate a range 802 on the fish-eye image by dragging a cursor 801 from a position clicked therewith so as to draw a circle in the first displaying region 510. The cursor 801 may be a mouse cursor or may indicate a touch position on the touch screen. As another example, the user may designate a range 812 on the fish-eye image by moving the cursor 801 in the first displaying region 510 in a free-hand manner so as to surround a certain range.

As in the example illustrated in FIG. 8, the conversion coordinate designation section 303 receives the input of surrounding the part on the fish-eye image by a line. Moreover, the conversion coordinate designation section 303 designates, as the range of the planar image formation, a range surrounded by the line.

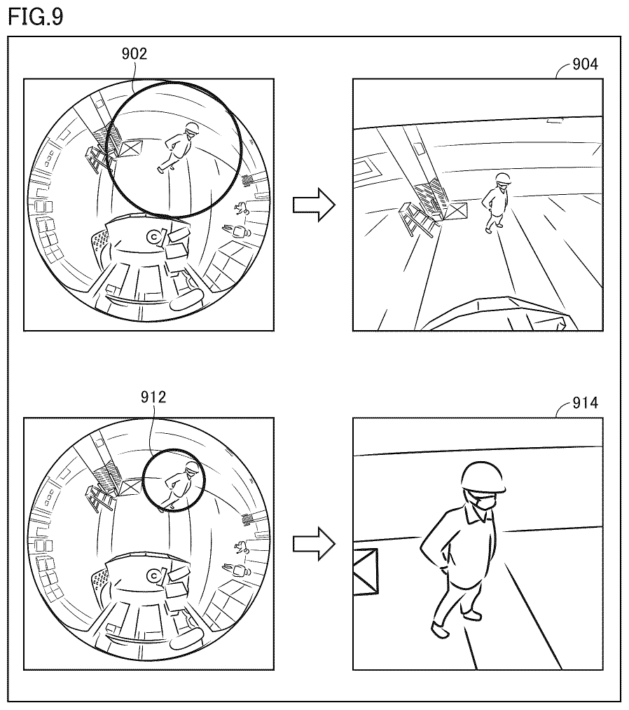

FIG. 9 is a diagram illustrating an example of a relation between the designated range and the generated planar image. Each of ranges 902, 912 is a range designated by the user on the fish-eye image. The range 902 includes a range wider than the range 912. The planar image 904 is a planar image generated based on the range 902. The planar image 904 is a planar image including at least the range 902. The planar image 914 is a planar image generated based on the range 912. The planar image 914 is a planar image including at least the range 912. It is understood that the planar image 904 includes a wider range (high angle of view) than the planar image 914. That is, as the range designated by the user on the fish-eye image is larger, the generated planar image has a higher angle of view.

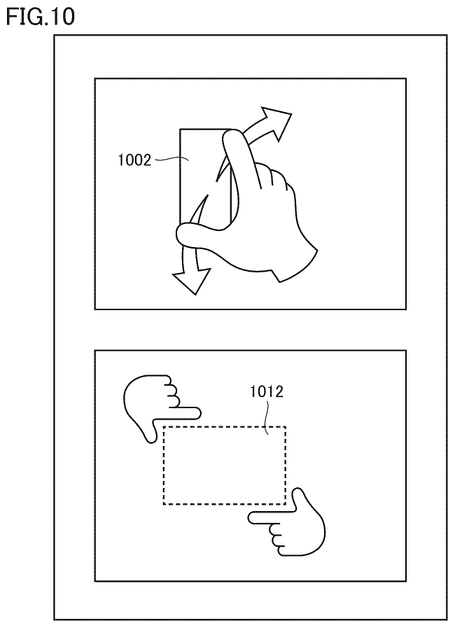

FIG. 10 is a diagram illustrating a third example of the method of designating the range of the planar image formation from the fish-eye image. The third example is a method of designating any range on the fish-eye image by a gesture with a finger or hand. The user can designate any range on the fish-eye image using a gesture with a finger or hand. Each of the systems 10, 20 generates a planar image including the range designated by the gesture. According to a certain embodiment, each of the systems 10, 20 can recognize the user's gesture by the touch screen. In this case, the first displaying region 510 can be displayed to overlap with the touch screen. According to another embodiment, each of the systems 10, 20 can recognize the user's gesture by a camera (not illustrated) provided near the display of each of the apparatuses 100, 250.

As an example, the user may designate a range 1002 on the fish-eye image by spreading two fingers in the first displaying region 510. As another example, the user may designate a range 1012 on the fish-eye image by forming a rectangle with both hands in the first displaying region 510.

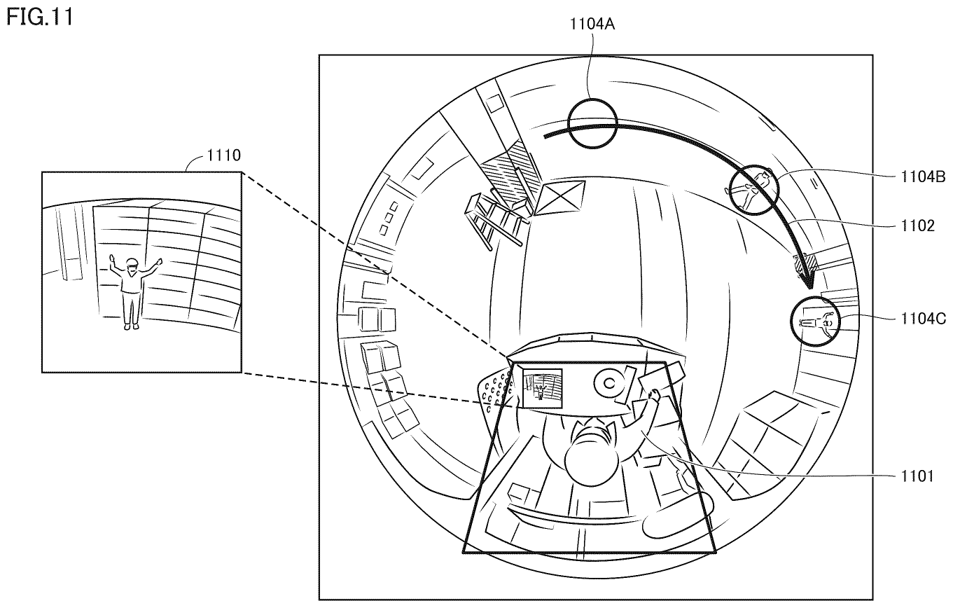

FIG. 11 is a diagram illustrating a fourth example of the method of designating the range of the planar image formation from the fish-eye image. The fourth example is a method of designating any range on the fish-eye image by a gesture with an arm of the operator of the movable body. The user can designate any range on the fish-eye image using the gesture with an arm. Each of the systems 10, 20 can recognize the user's gesture by analyzing an image captured by the camera 110. As an example, the user can perform the gesture by, for example, extending the user's arm to indicate a target or moving the user's arm to designate a range. Each of the systems 10, 20 can perform the planar image formation of the range indicated by the user's arm. Alternatively, each of the systems 10, 20 can perform the planar image formation of the range including the target in a direction or range indicated by the user's arm. Each of the systems 10, 20 can determine, by a known image recognition technique, whether or not the target is present in the direction or range indicated by the user's arm.

As an example, each of the systems 10, 20 recognizes movement of an arm 1101 of the user by image recognition processing. In the example of FIG. 11, the user moves the arm 1101 along an arrow 1102. In this case, each of the systems 10, 20 specifies ranges 1104A, 1104B, 1104C in each of which a target is present on the range indicated by the arms 1101 of the user (the range along the arrow 1102). Each of the systems 10, 20 can determine the presence or absence of the target by a known image recognition technique. Each of the systems 10, 20 generates a planar image including each of the ranges 1104A, 1104B, 1104C. On the display of each of the apparatuses 100, 250, one or more planar images 1110 including the designated ranges are displayed.

As described above, the camera 110 that captures the fish-eye image is provided in the movable body. The fish-eye image captures the operator of the movable body. The conversion coordinate designation section 303 analyzes the gesture of the operator captured in the fish-eye image and designates, as the range of the planar image formation, the range indicated by the gesture. Thus, the operator (user) of the movable body can select the range around the movable body to be subjected to the planar image formation, by a simple movement while operating the movable body. As a result, the user can concentrate on the operation of the movable body, thereby suppressing occurrence of an accident.

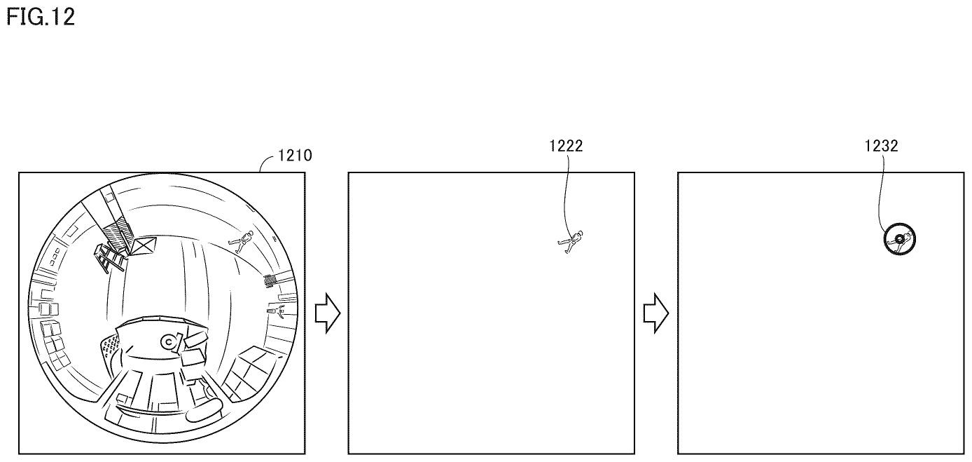

FIG. 12 is a diagram illustrating a fifth example of the method of designating the range of the planar image formation from the fish-eye image. The fifth example is a method of automatically designating any range on the fish-eye image by using a background subtraction method. Each of the systems 10, 20 generates a planar image of a range including a target specified by the background subtraction method.

In the example of FIG. 12, each of the systems 10, 20 detects, from history of a plurality of frames of a fish-eye image 1210, a target 1222 that is being moved. More specifically, each of the systems 10, 20 separates the background and the movable body from a difference obtained by comparing the plurality of frames. Furthermore, each of the systems 10, 20 generates a planar image of a range 1232 including the target specified by the background subtraction method. According to a certain embodiment, the generated planar image may include the range 1232 and its periphery, or may include only the range 1232.

Furthermore, each of the systems 10, 20 calculates the position and area of the target. Furthermore, each of the systems 10, 20 calculates the radius from the area of the target and calculates an FOV (Field of View) (viewing angle) that is a parameter when generating the planar image. Furthermore, each of the systems 10, 20 calculates the center of gravity of the target. Furthermore, each of the systems 10, 20 calculates, from the center of gravity of the target, a horizontal rotation angle and a vertical rotation angle, each of which is a parameter when generating the planar image. According to a certain embodiment, each of the systems 10, 20 can specify the target using template matching, determination with color, and any other image processing technique.

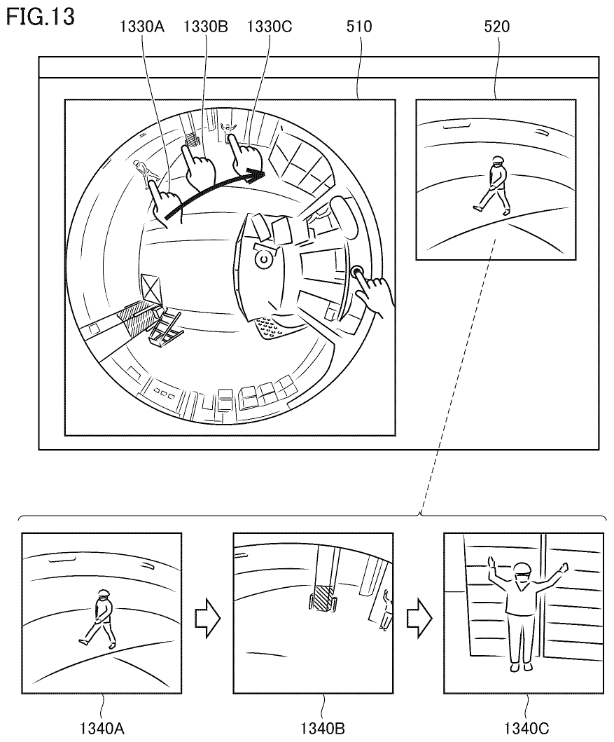

FIG. 13 is a diagram illustrating a sixth example of the method of designating the range of the planar image formation from the fish-eye image. The sixth example is a method of consecutively designating a plurality of points or ranges on the fish-eye image. The user can consecutively designate a point or a range on the fish-eye image using any means. Each of the systems 10, 20 generates a planar image including the designated point or range.

In the example of FIG. 13, the user designates three points 1330A, 1330B, 1330C in the first displaying region 510. Each of the systems 10, 20 can display, in the second displaying region 520, planar images 1340A, 1340B, 1340C corresponding to the three points 1330A, 1330B, 1330C, while consecutively switching the planar images 1340A, 1340B, 1340C. According to a certain embodiment, each of the systems 10, 20 can repeatedly display one or more generated planar images in the second displaying region 520 while consecutively switching the planar images. As an example, the user may slide a finger, a mouse cursor, a touch pen, or the like in the first displaying region 510. In this case, each of the systems 10, 20 samples the touched coordinates at a designated sampling rate. Each of the systems 10, 20 can calculate a horizontal rotation angle and a vertical rotation angle at the sampled coordinates, thereby generating a planar image.

As in the example illustrated in FIG. 13, the conversion coordinate designation section 303 consecutively receives inputs of one or more ranges on the fish-eye image. Moreover, the conversion coordinate designation section 303 sequentially designates the received one or more ranges as the ranges for the planar image formation.

FIG. 14 is a diagram illustrating a seventh example of the method of designating the range of the planar image formation from the fish-eye image. The seventh example is a method of designating a plurality of points or ranges on the fish-eye image. The user can designate a plurality of points or ranges on the fish-eye image using any means. Each of the systems 10, 20 generates a planar image including the plurality of designated points or ranges.

In the example of FIG. 14, the user designates a plurality of ranges 1430A, 1430B in the first displaying region 510. Each of the systems 10, 20 generates planar images 1440A, 1440B corresponding to the ranges 1430A, 1430B, and displays planar images 1440A, 1440B in the second displaying region 520.

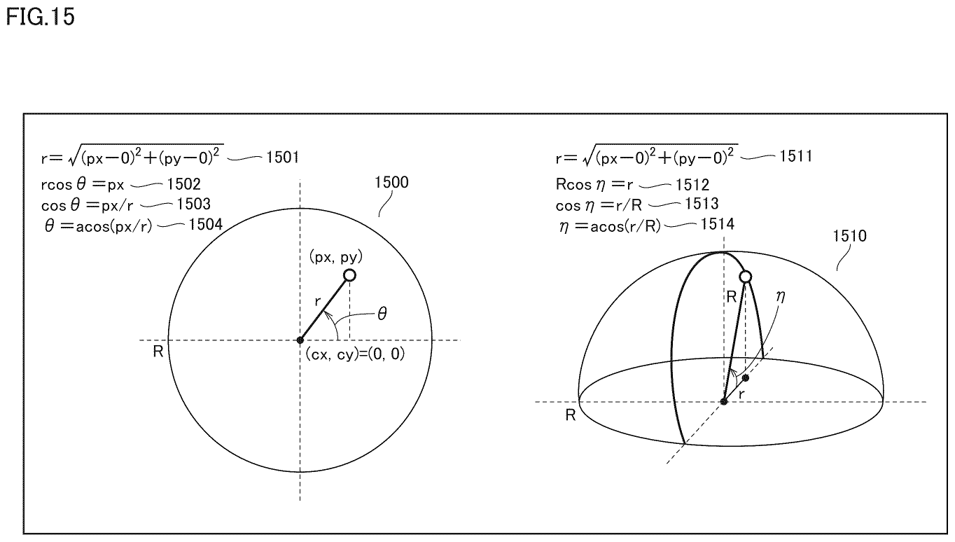

FIG. 15 is a diagram illustrating an example of a procedure for calculating the horizontal rotation angle and the vertical rotation angle. FIG. 15 illustrates a coordinate system 1500 when the fish-eye image is viewed from above and a coordinate system 1510 when the fish-eye image is viewed obliquely.

With the coordinate system 1500 as an example, each of the systems 10, 20 calculates a horizontal rotation angle θ based on formulas 1501, 1502, 1503, 1504. px and py are the coordinates of a point designated on the fish-eye image or the coordinates of the center point of a designated range. Each of the systems 10, 20 calculates px and py from the point or range input by the user. Next, each of the systems 10, 20 calculates the horizontal rotation angle θ using px and py and the formulas 1501 to 1504.

With the coordinate system 1510 as an example, each of the systems 10, 20 calculates a vertical rotation angle n based on formulas 1511, 1512, 1513, 1514, Each of the systems 10, 20 calculates the vertical rotation angle n using px and py and the formulas 1511 to 1514.

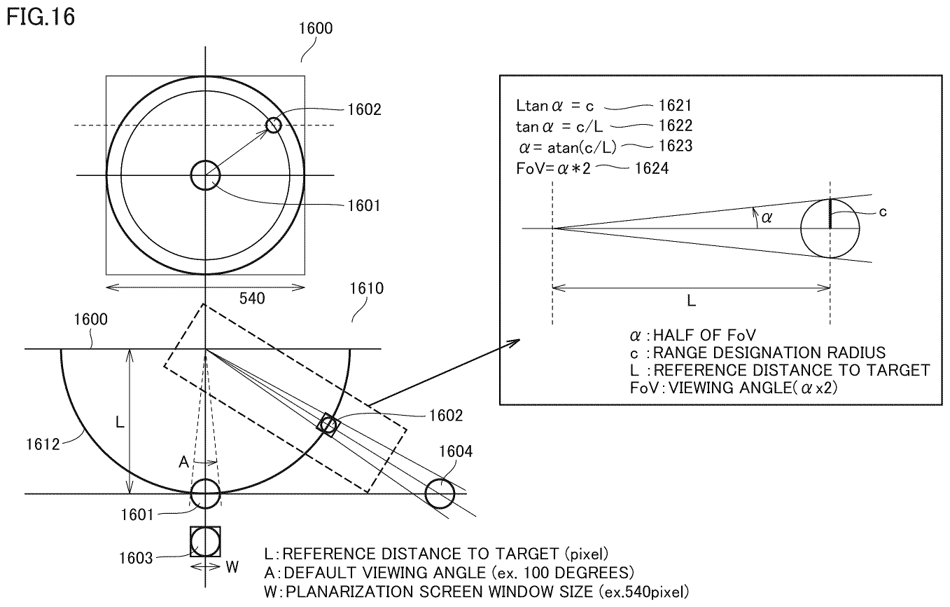

FIG. 16 is a diagram illustrating an example of a procedure for calculating the FOV. FIG. 16 illustrates a relation between a fish-eye image 1600 and a lateral plane 1610 of the camera 110, which is conceptually illustrated. According to the fish-eye image 1600, targets 1601, 1602 are captured in the fish-eye image. According to the lateral plane 1610, for example, the target 1601 corresponds to reflected light of an actual object 1603 that passes through the fish-eye lens 1612. The target 1602 corresponds to reflected light of an actual object 1604 that passes through the fish-eye lens 1612.

Each of the systems 10, 20 calculates the FOV by using a reference distance L to the target, a default viewing angle A, a planarization screen window size W, and formulas 1621, 1622, 1623, 1624. According to a certain embodiment, the reference distance L to the target, the default viewing angle A, and the planarization screen window size W may be input to each of the systems 10, 20 as settings in advance. Further, each of the systems 10, 20 may include a UI for inputting each of these settings.

### E. Flowchart

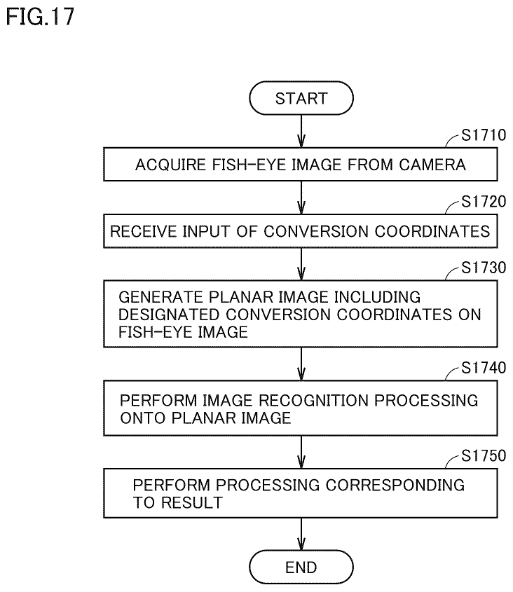

FIG. 17 is a diagram illustrating an example of a procedure of internal processing of each of the systems 10, 20. In the case of the system 10, the apparatus 100 can perform the procedure illustrated in FIG. 17. In the case of the system 20, the apparatus 200 can perform the procedure illustrated in FIG. 17. Alternatively, in the case of the system 20, the apparatus 200 and the apparatus 250 can perform the procedure illustrated in FIG. 17 in cooperation.

According to a certain embodiment, the CPU 1 may load a program for performing the processing of FIG. 17 from the secondary storage device 3 into the primary storage device 2, and execute the program. In another aspect, part or whole of the processing may be implemented as a combination of circuit elements configured to perform the processing.

In a step S1710, each of the systems 10, 20 (the image input section 302) acquires a fish-eye image from the camera 110.

In a step S1720, each of the systems 10, 20 (the conversion coordinate designation section 303) receives an input of conversion coordinates. The conversion coordinates are the center coordinates of a range of planar image formation. According to a certain embodiment, each of the systems 10, 20 may receive an input of a range. In this case, each of the systems 10, 20 can calculate the conversion coordinates (center coordinates) from the range.

More specifically, as an example, each of the systems 10, 20 receives the input of the conversion coordinates or the range from the user by each of the methods illustrated in FIG. 7 to FIG. 14. The user designates the conversion coordinates or range by using various UIs provided by each of the systems 10, 20. The various UIs include the camera 110, an eye tracking device, a touch screen, a screen of a web application, any other UIs, and a combination thereof.

In a step S1730, each of the systems 10, 20 (the image conversion section 304) generates a planar image including the designated conversion coordinates on the fish-eye image (converts the designated range into a planar image). As an example, each of the systems 10, 20 can use the image conversion technique illustrated in FIG. 6 for the processing of this step.

In a step S1740, each of the systems 10, 20 (the image recognition section 305) performs image recognition processing onto the generated planar image. As an example, each of the systems 10, 20 can perform processing for determining the presence or absence of a target that is moved and/or processing for calculating the distance from the target to the movable body, for example. Moreover, each of the systems 10, 20 can also perform processing for determining an attribute (such as a person or an AGV) of the target, and the like.

In a step S1750, each of the systems 10, 20 (the output section 306) performs processing corresponding to the result of the image recognition processing. According to a certain embodiment, each of the systems 10, 20 can display the screen 500 on the display of each of the apparatuses 100, 250. According to another embodiment, each of the systems 10, 20 can output an alert in accordance with a distance from the target to the movable body, or the like. The alert may be displayed on the screen 500. The alert may be output by a buzzer sound, a voice, or the like. Alternatively, the alert may include both of the output to the screen and the output by a buzzer sound, a voice, or the like.

As described above, each of the systems 10, 20 according to the present embodiment have the function of selecting a part on a fish-eye image and the function of generating a planar image including the selected range. Thus, the user can select an attention-attracting part on the fish-eye image with a simple operation and check the part on the planar image. Further, each of the systems 10, 20 can calculate the horizontal rotation angle, the vertical rotation angle, and the FOV from the point designated by the user through the processing illustrated in FIGS. 15 and 16 and the like. Thus, the user can automatically determine the viewing angle in addition to the range of the planar image formation only by selecting the attention-attracting part on the fish-eye image.

The embodiments disclosed herein are illustrative and non-restrictive in any respect. The scope of the present disclosure is defined by the terms of the claims, rather than the embodiments described above, and is intended to include any modifications within the scope and meaning equivalent to the terms of the claims. Moreover, the contents of disclosure as described in the embodiments and the modification examples are intended to be implemented solely or in combination as much as possible.

### REFERENCE SIGNS LIST

1 CPU; 2 primary storage device; 3 secondary storage device; 4 external device interface; 5 input interface; 6 output interface; 7 communication interface; 10, 20 system; 100, 200, 250 apparatus; 101 output device; 102 input device; 103, 203 storage; 110 camera; 140, 1222, 1601, 1602 target; 302 image input section; 303 conversion coordinate designation section; 304 image conversion section; 305 image recognition section; 306 output section; 500 screen; 510 first displaying region; 520 second displaying region; 530A, 530B, 530C, 615, 802, 812, 902, 912, 1012, 1102, 1104A, 1104B, 1104C, 1232, 1430A, 1430B range; 540, 540A, 540B, 540C, 630, 904, 914, 1110, 1340A, 1340B, 1340C, 1440A, 1440B planar image; 610, 1210, 1600 fish-eye image; 620 equirectangular image; 701, 801 cursor; 711 line of sight; 1101 arm; 1500, 1510 coordinate system; 1603, 1604 actual object; 1610 lateral plane; 1612 fish-eye lens.

1. An image processing apparatus comprising:
a receiver that receives an input of a fish-eye image;
a processor that:
designates a part on the fish-eye image as a range of planar image formation based on an input of a user; and
converts the designated range on the fish-eye image into a planar image.

2. The image processing apparatus according to claim 1, wherein
a camera that captures the fish-eye image is provided at a movable body,
the fish-eye image captures an operator of the movable body,
the processor analyzes a gesture of the operator captured in the fish-eye image, and
the processor designates, as the range of the planar image formation, a range indicated by the gesture.

3. The image processing apparatus according to claim 1, wherein
the processor receives an input of one or more points on the fish-eye image, and
the processor designates, as the range of the planar image formation, a range centered on each of the one or more points.

4. The image processing apparatus according to claim 1, wherein
the processor receives an input of surrounding a part on the fish-eye image by a line, and
the processor designates, as the range of the planar image formation, each of one or more ranges surrounded by the line.

5. The image processing apparatus according to claim 1, wherein
the processor consecutively receives an input of one or more ranges on the fish-eye image, and
the processor sequentially designates each of the one or more ranges as the range of the planar image formation.

6. The image processing apparatus according to claim 1, wherein the processor that performs image recognition processing onto the planar image.

7. The image processing apparatus according to claim 6, further comprising a transmitter that outputs the fish-eye image and the planar image, wherein
the transmitter outputs an image recognition result and/or an alert that is based on the image recognition result.

8. An image processing system comprising:
a camera having a fish-eye lens;
a receiver image input section that receives a fish-eye image from the camera;
a processor that
designates a part on the fish-eye image as a range of planar image formation based on an input of a user; and
converts the designated range on the fish-eye image into a planar image.

9. A non-transitory computer-readable medium storing instructions that, when executed by a computer, cause the computer to perform:
receiving an input of a fish-eye image from a camera;
designating a part on the fish-eye image as a range of planar image formation based on an input of a user; and
converting the designated range on the fish-eye image into a planar image.
